(19) United States
(12) Patent Application Publication
(10) Pub. No.: US 2024/0249199 A1
(43) Pub. Date: Jul. 25, 2024

(54) VERIFYING AN ACTION PROPOSED BY A REINFORCEMENT LEARNING MODEL

(71) Applicant: Telefonaktiebolaget LM Ericsson (publ), Stockholm (SE)

(72) Inventors: Jaeseong JEONG, Solna (SE); Burak DEMIREL, Älvsjö (SE); Harshit TATED, Bangalore (IN); Wenfeng HU, Täby (SE)

(73) Assignee: Telefonaktiebolaget LM Ericsson (publ), Stockholm (SE)

(21) Appl. No.: 18/564,108

(22) PCT Filed: May 26, 2021
(86) PCT No.: PCT/EP2021/064101

§ 371 Date: Nov. 27, 2023

(51) Int. Cl. G06N 20/00

(52) U.S. Cl. CPC G06N 20/00

(57) ABSTRACT

The present disclosure provides a computer-implemented method for determining whether to perform an action proposed by a model. The model is developed using a reinforcement learning process. The method comprises classifying at least one of a plurality of inputs to the model as being supportive or resistant to an action proposed by the model. The method further comprises comparing the classification of the at least one of the plurality of inputs to domain knowledge to determine whether or not the proposed action conflicts with the domain knowledge, and, in response to determining that the proposed action does not conflict with the domain knowledge, initiating the proposed action. In this context, the domain knowledge is indicative of a relationship between the proposed action and the at least one of the plurality of inputs.

### TECHNICAL FIELD

Embodiments of the present disclosure relate to computer-implemented methods, computer programs and apparatuses for determining whether to perform an action proposed by a model developed using a reinforcement learning process.

### BACKGROUND

In reinforcement learning (RL), a learning agent interacts with an environment and performs actions through a trial-and-error process in order to maximize a reward. Deep reinforcement learning (DRL) combines reinforcement learning with deep learning to guide the learning agent's decisions, which allows for scaling reinforcement learning to more complex problems such as those involving larger state spaces and unstructured datasets. In the last decade, deep reinforcement learning has gained popularity thanks to its successful application in various domains such as wireless networks, robotics, and many other disciplines.

Models developed using reinforcement learning are sensitive to the data used for model training. Noise in training data can lead to biased or contaminated models, which may make flawed decisions, such as recommending actions that could lead to negative outcomes. One approach for addressing this issue is to employ a verification step such that any action proposed by the model is verified before it is executed. However, this can be time consuming and may require operator involvement.

In addition, it may not be apparent whether or not an action suggested by a reinforcement learning model is due to flawed reasoning. One advantage of reinforcement learning processes is that they can capitalise on insights that may not be apparent to a human operator analysing the same data. Effectively verifying the outputs of these models requires differentiating between proposals arising from flawed logic (e.g. as a result of bias or contamination), and proposals arising from novel insights into the environment in which the model operates.

Reinforcement learning often exhibits a trade-off between performance and transparency. For deep reinforcement learning in particular, the deep learning processes employed to guide decisions can act in a black-box manner, making it difficult to understand the behaviour of the model. This lack of insight into the reasons for a recommendation by a model can make effective verification particularly challenging. Whilst some authors have proposed methods for verifying deep reinforcement learning models (see, for example, Verifiable Reinforcement Learning via Policy Extraction, arXiv: 1805.08328v2, January 2019), this can involve adapting the model itself to make it verifiable, which may not be possible or desirable for real-world implementations of reinforcement learning models.

### SUMMARY

The present disclosure seeks to address these and other problems.

In a first aspect, a computer-implemented method for determining whether to perform an action proposed by a model is provided. The model is developed using a reinforcement learning process. The method comprises classifying at least one of a plurality of inputs to the model as being supportive or resistant to an action proposed by the model. The method further comprises comparing the classification of the at least one of the plurality of inputs to domain knowledge to determine whether or not the proposed action conflicts with the domain knowledge, and, in response to determining that the proposed action does not conflict with the domain knowledge, initiating the proposed action. In this context, the domain knowledge is indicative of a relationship between the proposed action and the at least one of the plurality of inputs.

In a further aspect, an apparatus configured to perform the aforementioned method is provided. In another aspect, a computer program is provided. The computer program comprises instructions which, when executed on at least one processor of an apparatus, cause the apparatus to carry out the aforementioned method. In a further aspect, a carrier containing the computer program is provided, in which the carrier is one of an electronic signal, optical signal, radio signal, or non-transitory machine-readable storage medium (e.g. a memory).

A still further aspect of the present disclosure provides an apparatus for determining whether to perform an action proposed by a model developed using a reinforcement learning process. The apparatus comprises a processor and a machine-readable medium, in which the machine-readable medium contains instructions executable by the processor such that the apparatus is operable to classify at least one of a plurality of inputs to the model as being supportive or resistant to a proposed action by the model. The apparatus is further operable to compare the classification of the at least one of the plurality of inputs to domain knowledge to determine whether or not the proposed action conflicts with the domain knowledge, in which the domain knowledge is indicative of a relationship between the proposed action and the at least one of the plurality of inputs. The apparatus is further operable to initiate the proposed action in response to determining that the proposed action does not conflict with the domain knowledge.

Embodiments of the disclosure may have one or more technical advantages. Classifying the inputs to the model as either supportive or resistant captures the contribution of the inputs to the decisions made by the model in a manner which simplifies the comparison with domain knowledge. Comparing the classification with domain knowledge identifies instances in which the decision-making of the model may be flawed, allowing actions which may lead to negative or undesired outcomes to be identified before the action is performed. More specifically, evaluating the proposals made by the model in this manner effectively distinguishes between proposals arising from flawed logic (e.g. as a result of bias or contamination), and proposals arising from novel insights into the environment in which the model operates. In addition, the method can identify risky actions without requiring, for example, each action proposed by the model to be checked by an operator. This can reduce the time taken to implement actions recommended by the model.

Some embodiments of the disclosure provide for an input mapper, or mapping model, which maps inputs to the reinforcement learning model to one or more events. In these examples, conflicts may be determined to occur solely based on any contradictions between such events and the domain knowledge. This may be particularly advantageous for fields in which the reinforcement learning model inputs typically comprise low-level parameters (e.g. raw measurement data), but the domain knowledge is abstracted in terms of higher level representations or concepts. As a result, conflicts between low-level metrics (e.g. metrics that are not easily interpreted) and higher-level domain knowledge may still be identified.

The methods described herein may be implemented in a variety of different scenarios or use cases. For example, the methods may be used in communication networks to verify actions proposed by models developed using reinforcement learning. Network performance may be improved by reducing the risk of actions that may be detrimental to network performance being performed, whilst still allowing novel insights of a model developed using reinforcement learning to be fully utilised. This can result in a more dynamic and adaptable network since operational parameters of the network can be more efficiently adjusted to account for changes in network conditions.

Alternative use cases include robotics, smart factories and autonomous vehicles. In these use cases, implementation of the methods described herein may improve the safety of the systems by reducing the likelihood of a dangerous proposed action being initiated.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows a schematic diagram of a system according to embodiments of the disclosure;

FIG. 2 is a flowchart of a method according to embodiments of the disclosure; and

FIGS. 3 and 4 show schematic diagrams of apparatuses according to embodiments of the disclosure.

### DETAILED DESCRIPTION

Models developed using reinforcement learning may be susceptible to bias or contamination as a result of, for example, the environment used to develop the model or the reward function employed during training. This can lead flawed decision-making that may lead to undesired outcomes.

This can be illustrated by considering an exemplary model developed using reinforcement learning for deployment in a communication network. The model is configured to optimize operational parameters for a base station in the network to improve network performance. The operational parameters may include, for example, a transmit power, an antenna tilt, a sector shape or any other suitable parameter for controlling the operation of the base station.

The inputs for the model comprise metrics that are indicative of network performance. For example, the inputs to the model may comprise a first metric indicating that interference experienced by wireless devices served by the base station is high and a second metric indicating that coverage provided by the base station is low. Based on these inputs, the model may propose increasing the base station transmission power. However, increasing the base station transmission power may not be advisable when interference is high because it can lead to increased interference (e.g. for devices neighbouring a receiver). The model may have proposed this action due to flawed reasoning that occurred due to, for example, issues with the data used to train the model, issues with the reward function when training the model or noise in the data input to the model. As the model may have failed to account for the risk of worsening interference, it should be rejected.

However, the model may be configured to receive a large number of inputs, which means that contradictions between different network metrics are likely to occur. If action proposals are rejected simply because they contradict an input metric, then a large proportion of actions proposed by the model may be rejected. This reduces the utility of the reinforcement learning model.

Whilst this example is specific to communication networks, the skilled person will appreciate that similar issues may arise wherever models developed using reinforcement learning are used. The problems may be exacerbated for domains having large state spaces (as the chance of contradictory inputs may increase for increasing numbers of inputs), such as domains in which deep reinforcement learning is often employed.

Embodiments of the disclosure seek to address these and other problems. One example provides a computer-implemented method for determining whether to perform an action proposed by a model developed using reinforcement learning. The method comprises classifying the inputs to the model as either supportive or resistant to the proposal of the action. Some inputs to the model may increase the likelihood of the model proposing the particular action and may thus be classed as supportive. Other inputs may decrease the likelihood of that action being proposed and may thus be classed as resistant. The method further comprises comparing the classification of the inputs to domain knowledge indicative of a relationship between the action and one or more of the inputs. If it is determined that there is no conflict between the proposal of the action and the domain knowledge, the action is initiated.

Classifying the inputs to the model as either supportive or resistant captures the contribution of the inputs to the decisions made by the model in a manner which simplifies the comparison with domain knowledge. Comparing the classification with domain knowledge identifies instances in which the decision-making of the model may be flawed, allowing actions which may lead to negative or undesired outcomes to be identified before the action is performed. More specifically, evaluating the proposals made by the model in this manner effectively distinguishes between proposals arising from flawed logic (e.g. as a result of bias or contamination), and proposals arising from novel insights into the environment in which the model operates. In addition, the method can identify risky actions without requiring, for example, each action proposed by the model to be checked by an operator.

Thus in the aforementioned example of a model proposing to increase the transmission power for a base station based on metrics indicating that there is high interference and low coverage, according to the methods disclosed herein the metrics would be classified as either supportive or resistant to the proposed action and the classification would be compared to the domain knowledge to determine whether there is a conflict. If, for example, the metric indicating that interference is high is classed as supportive, then this classification would contradict domain knowledge indicating that the transmission power should not be increased when interference is high. As a result, a conflict between the domain knowledge and the proposed action may be identified, as the contradiction between the classification and the domain knowledge indicates that the logic used by the model may be flawed. This may prevent the transmission power from being increased.

Alternatively, if the metric indicating that interference is high is classed as resistant, then this may indicate that the model has accounted for the detrimental effect of the proposed action (increasing transmission power) on the interference. Thus, the model may, for example, accept this negative outcome as worthwhile to improve another aspect of network performance. In this situation, the classification of the metric as resistant would not contradict the domain knowledge and thus a conflict would not be detected. The transmission power would thus be increased.

Implementing this method in a communication network may thus reduce the risk that actions that may be detrimental to network performance are initiated, whilst still allowing novel insights of model developed using machine learning to be fully utilised. In addition, in situations in which a human verifier is available to validate or check actions recommended by the model, the embodiments described herein can reduce the number of actions that are sent to the verifier for validation, which can reduce the time taken to implement actions recommended by the model. This can result in a more dynamic and adaptable network since operational parameters of the network can be more efficiently adjusted to account for changes in network conditions.

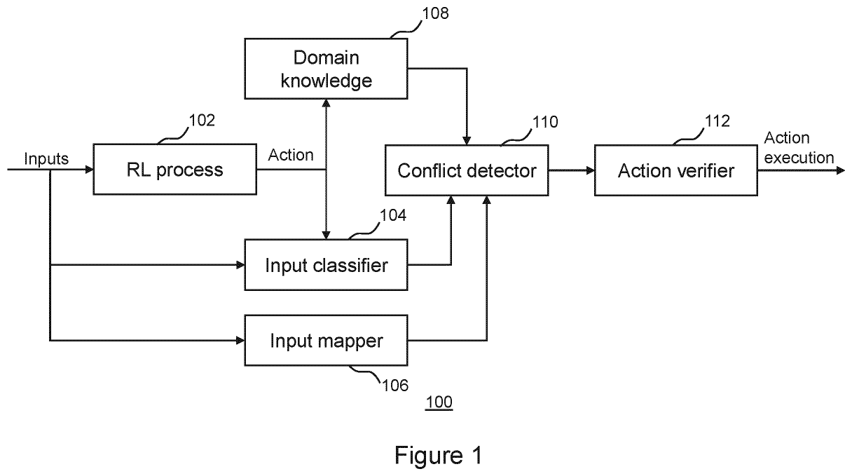

FIG. 1 shows a schematic diagram of a system 100 according to embodiments of the invention. The system 100 is configured to determine whether or not to perform an action proposed by a model 102 based on inputs to the model 102.

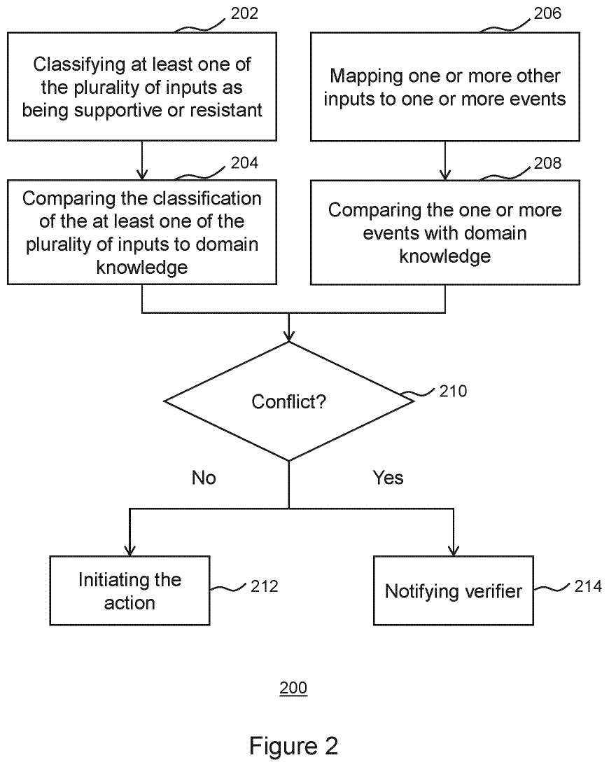

In addition to the model 102, the system 100 comprises an input classifier 104, an input mapper 106, a domain knowledge unit 108, a conflict detector 110 and an action verifier 112. The operation of these units is discussed in more detail with respect to FIG. 2, which shows a flowchart of a method 200 performed by the system 100 according to embodiments of the disclosure.

The method 200 is for determining whether or not to perform an action proposed by the model 102, in which the model 102 is developed using a reinforcement learning process.

The skilled person will be familiar with reinforcement learning, so it is not discussed in detail here. Briefly, reinforcement learning is a type of machine learning process whereby a reinforcement learning agent (e.g. an algorithm or process) is used to perform actions on a system (such as a communication network) to adjust the system according to an objective. The reinforcement learning agent receives a reward based on whether the action changes the system in compliance with the objective, or against the objective. The reinforcement learning agent therefore adjusts parameters in the system with the goal of maximising the rewards received. Exemplary reinforcement learning processes include policy optimisation processes and q-learning processes, which are discussed in more detail below. The model 102 may thus comprise, for example, a policy network or a Q-network.

The method 200 begins with the model 102 determining an action to be performed based on a plurality of inputs. In alternative embodiments, the model 102 may not form part of the system 100, and may instead be executed elsewhere. The method 200 may thus comprise receiving the proposed action from another node which executes the model 102.

The model inputs will vary according to the domain or environment in which the method 200 is being used. The inputs indicate the current state, s, of the domain or environment to which the model 102 is being applied.

Based on the plurality of inputs, the model 102 outputs a proposal of an action to be performed. In examples in which the model 102 is developed using a policy optimisation process, the model 102 may comprise a policy network configured to obtain a set of probabilities of possible actions, π, based on the plurality of inputs. The model 102 may sample an action a from the probability distribution π(s) based on the state s and output the action a as an action to be performed.

In alternative examples in which the model 102 is developed using a q-learning process, the model 102 may comprise a Q-network configured to obtain a set of Q-values of possible actions based on the plurality of inputs. The Q-values represent an estimate of the expected future reward from taking a particular action a in state s. Based on the Q-values, the model 102 selects an action to perform. For example, the model 102 may select the action aₘₐₓ associated with the highest (maximum) Q-value to be initiated.

In step 202, the input classifier 102 classifies at least one of the plurality of inputs as being supportive or resistant to the proposal of the action.

Inputs that encouraged the model 102 to propose the action may be classified as supportive. Thus, inputs that increased the probability of the action being proposed may be considered supportive. Inputs that opposed the proposal of the action (e.g. decreased the probability of the action being proposed) may be considered resistant. In embodiments in which the model 102 comprises a policy network, inputs which pushed the probability distribution π(s,a) for a particular action a higher may be classed as supportive, whereas inputs which pushed the probability distribution π(s,a) lower may be classed as resistant. In embodiments in which the model comprises a Q-network, inputs which pushed the Q-value Q(s,aₘₐₓ) for a particular action aₘₐₓ higher may be classed as supportive, whereas inputs which pushed Q(s,aₘₐₓ) lower may be classed as resistant.

The inputs may be classified as supportive or resistant using an explainable artificial intelligence (XAI) process. The skilled person will be familiar with XAI, but in brief, in order to understand a model (e.g. a model developed using a reinforcement learning process), an XAI method performs tests to extract the model characteristics. Generally, the inputs to an XAI process are: data input to the model, the model, and the prediction or proposal of the model (e.g. the proposed action). The output of the XAI process is the explanation e.g. information describing how the model determined its prediction from the data input to it. More detail on relevant XAI concepts may be found in Explainable Reinforcement Learning: A Survey, arXiv: 2005.06247, May 2020.

There are many XAI methods that may be used in the methods described herein. Two particular relevant XAI methods are the SHapley Additive explanations (SHAP) framework, described in A Unified Approach to Interpreting Model Predictions, Scott M. Lundberg and Su-In Lee, NeurIPS, 2017, and Local Interpretable Model-agnostic Explanations (LIME), described in “Why Should I Trust You?: Explaining the Predictions of Any Classifier”, Marco Tulio Ribeiro, Sameer Singh and Carlos Guestrin, arXiv: 1602.04938, February 2016.

Thus, the input classifier 104 may input the model 102, the plurality of model inputs and the action proposed by the model 102 into an XAI process, such as SHAP or LIME, and obtain, from the XAI process, a classification of each of the plurality of inputs as either supportive or resistant to the action proposal. In particular examples, the input classifier 104 may pre-process one or more of the inputs before using the XAI. For example, the input classifier 104 may compare an input having a value of 0.1 to a threshold value and, based on that comparison, determine that the value of the input is “low”. The input classifier 104 may thus convert that input value from 0.1 to “low”. This pre-processing step may simplify comparison with domain knowledge, as discussed in more detail below.

Alternatively, the input classifier 104 may receive classifications of the inputs as either supportive or resistant from another device or node (not illustrated). For example, another node may execute an XAI process and step 202 may comprise receiving the classifications (e.g. the output of the XAI process) from the node.

In some embodiments, the input classifier 104 may further determine a relative importance of the inputs to the proposed action. Thus, the classifier may determine which of the inputs was most influential or determinative in the decision, by the model 102, to propose the action. For example, one input may be classed as being of low or no importance if it had little or no effect on the decision to propose the action.

The input classifier 104 may determine the relative importance of the inputs using an XAI process. For example, the XAI process used to classify the inputs may also associate each input with a relative importance indicating the influence the respective input had on the decision relative to the other inputs. Thus, each input may be assigned a number indicating its relative importance; one example of such a number is the Shapley value associated with each input. The number indicating relative importance may be defined on a scale (e.g. a scale from 0 to 1, in which 0 is no importance and 1 is the maximum level of importance). Alternatively, the input classifier 104 may receive the relative importance of the inputs from another node. For example, another node may execute an XAI process and the classifier 104 may receive the relative importance values (e.g. an output of the XAI process) from the other node.

In particular embodiments, the input classifier 104 may use the relative importance to inform the classifications of the inputs. Thus, an input may only be classed as supportive or resistant if its contribution to the decision is determined to be above a minimum threshold. For example, inputs having a minimum level of importance may be classified as supportive or resistant, whereas inputs not having this minimum level of importance may not be classified or may be ignored.

In step 204, the conflict detector 110 compares the classification of the inputs to domain knowledge. The skilled person will be familiar with the concept of domain knowledge, but briefly domain knowledge comprises information which is specific to the domain or environment in which the model operates. Thus, the domain knowledge may relate to expertise or know-how in a particular field. Domain knowledge is typically produced using input from (human) experts in that field.

In the embodiments described herein, the domain knowledge is indicative of a relationship (e.g. a causal relationship) between at least some of the plurality of inputs and the action proposed by the model. Thus, for example, the domain knowledge may predict the impact of performing the proposed action on one or more of the inputs.

The domain knowledge may be generated in various ways. For example, the domain knowledge may be generated by a human operator, such as an expert in the particular field or domain in which the model is employed. In these examples, the domain knowledge may comprise, for example, rule-based logic (e.g. perform a particular action in response to determining that a first metric is above a threshold value), and/or finite state automata.

Alternatively, the domain knowledge may be developed using a machine learning process, with subsequent verification by an expert. In these examples, the domain knowledge may comprise, for example, a knowledge graph, a causal graph and one or more patterns recognised by the machine learning process, e.g., Bayesian networks, natural-language processing ontologies, etc.

In particular embodiments, the domain knowledge comprises one or more causal relationships between at least some of the plurality of inputs and the action proposed by the model, in which the relationships were determined using causal representation learning, such as that described in “Towards Causal Representation Learning” arXIV: 2102, February 2021. The causal relationships may be further verified by domain experts.

The domain knowledge may indicate one or more events which, according to the expertise or know-how in that domain, should trigger performance of the action. Thus, for example, these may be events which would prompt a human operator with expertise in the field to initiate the action. These events may be referred to as an “action-relevant” event set. These events may, for example, indicate particular values or a range of values for model inputs. In some examples, it may be sufficient for the domain knowledge to comprise a list of, or a list of indications of, events which should trigger performance of the action. Thus, the domain knowledge may comprise a list of action-relevant events or events which, according to expertise in the domain, support performing the action.

In the system 100, the domain knowledge is obtained by a domain knowledge unit 108, which retrieves the domain knowledge that is relevant to the action received from the model 102. The domain knowledge may be stored in the system 100 or received at the domain knowledge unit 108 from another device or node, for example.

In step 204, the conflict detector 110 compares the classification with the domain knowledge to determine, in step 210, whether or not there is a conflict between the proposed action and the domain knowledge. By comparing the classification with domain knowledge, the conflict detector 110 can determine whether or not the logic used by the model runs counter to existing knowledge in the field of application.

As discussed above, the classifier 104 may also determine the relative importance of the inputs. The skilled person will appreciate that some inputs may have little or no bearing on the proposal of the action made by the model 102. Thus, any conflict between the classification of these inputs with domain knowledge may be of little or no importance since the inputs had little or no effect on the decisions made by the model 102. Therefore, the conflict detector 110 may use the relative importance of the inputs to select a subset of the inputs to compare to the domain knowledge. For example, the conflict detector 110 may select a predefined number of inputs determined to have the highest importance for comparison with the domain knowledge. Alternatively, the conflict detector 110 may select all inputs with a minimum importance (e.g. all inputs determined to be of “high” importance) for comparison with the domain knowledge.

Narrowing down the number of inputs used for comparison with domain knowledge in this manner ensures that only inputs that were actually used in the decision making are used to validate the action proposed by the model. This reduces the risk of, for example, a conflict being detected based on the classification of an input that had no meaningful impact on the proposal of the action and thus reduces the risk of an action being unnecessarily rejected.

Alternatively, the conflict detector 110 may compare all of the classifications received from the classifier 104 with the domain knowledge. In general, the conflict detector 110 may compare one or more of the input classifications with the domain knowledge.

A conflict may be determined to occur when one or more of the classifications contradicts the domain knowledge. For example, a first input may comprise a parameter having a particular value, and the input may be classified as supportive to the proposal of the action in step 202. However, the domain knowledge may indicate that the action should not be performed when the parameter has that value, thereby contradicting the classification.

In some embodiments, one contradiction may be sufficient to determine that a conflict exists. Thus, in examples in which the domain knowledge comprises an action-relevant event set, as described above, a conflict may be determined to occur when one input classified as supportive contradicts the action-relevant event set. Thus, for example, a conflict may be determined to occur when the action-relevant event set indicates that a parameter having a value below a particular threshold should be supportive of the action, but the input is classed as supportive despite have a value above this threshold.

Similarly, a conflict may be identified when an input classified as resistant corresponds to an event in the action-relevant event set. For example, the action-relevant event set may indicate that a parameter having a value below a particular threshold should be supportive of the action, but the input may be classed as resistant, despite have a value below this threshold. The conflict detector 110 may determine that the action conflicts with the domain knowledge by identifying this contradiction between the classification of the input as resistant and the action-relevant event.

In other embodiments, a conflict may only be identified if a minimum fraction or a threshold number of classifications contradict the domain knowledge, in which the threshold number is greater than one. Thus, for example, the conflict detector 110 may only identify a conflict when a certain fraction of inputs classified as supportive contradicts events in the action-relevant event set.

As discussed above, some or all of the inputs may be pre-processed by the input classifier 104 before classification to ease comparison with the domain knowledge.

The conflict detector 110 may use these pre-processed (e.g. converted) inputs when comparing classifications with domain knowledge. For example, an input with a value of 0.1 may be converted to “low” by the input classifier 104, which also classifies this input as supportive. In step 204, the input classifier may compare the classification with domain knowledge indicating that the action should only be performed when the value of that input is “high”. The conflict detector 110 may thus determine that the classification of the input value contradicts the domain knowledge and may thus determine that a conflict is present.

Alternatively, the conflict detector 110 may use the raw inputs when comparing classifications with domain knowledge. For example, an input having a value of 0.1 that is classified as supportive may be compared with domain knowledge that provides a relationship between a proposed action and the input having a value less than 0.5.

The skilled person will appreciate that there may be situations in which the inputs may not easily be converted for comparison with domain knowledge. Depending on the domain knowledge and the model inputs, situations may arise in which the model inputs and the domain knowledge may be parametrised or abstracted differently, making any comparison between the input classification and the domain knowledge prohibitively difficult. To address this, these inputs may, instead of being classified in step 202, be sent to the input mapper 106. Thus, some of the model inputs may be sent to the input classifier 104 for classification, whereas other inputs may be sent to the input mapper 106. The system 100 may determine whether to send inputs to the input mapper 106 or the classifier 104 based on the domain knowledge provided by the domain knowledge unit 108. Thus, for example, the system 100 may send an input to the input mapper 106 in response to determining that it is not referenced directly in the domain knowledge available to the domain knowledge unit.

The input mapper 106 is configured to map received inputs to corresponding events, in which the domain knowledge is parametrised (at least partially) in terms of the events. The input mapper 106 may thus be configured to, for example, convert low-level parameters or values into higher level representations for comparison with the domain knowledge.

Thus, in step 206, the input mapper 106 maps one or more inputs to one or more events. As the domain knowledge is parameterised in terms of the one or more events, mapping the inputs to these events enables comparing the model inputs with domain knowledge.

In some embodiments, the input mapper 106 may use a model trained using a machine learning process to map the inputs to events. The model may be domain-specific since it may rely on knowledge or information from the domain to determine relationships between the inputs and the events. An example of such a model for a communication network is discussed in more detail below.

In step 208, the conflict detector 110 compares the one or more events with domain knowledge to determine, in step 210, whether the proposed action conflicts with the domain knowledge.

Thus, as well as comparing the classifications from the input classifier 104 with the domain knowledge in step 204, the conflict detector 110 may also, in step 208, compare events from the input mapper 106 with the domain knowledge in order to identify any conflict.

These comparisons differ in that, in step 204, the classification of an input as either supportive or resistant which is compared to the domain knowledge. In contrast, in step 208, it is an event (representing one or more inputs) that is compared to the domain knowledge. Thus, the comparison in step 204 is indicative of the reasoning or logic used by the model 102 in determining the action. In contrast, the comparison in step 208 may not provide any insight into how the model works and instead may merely indicate the information that was input to the model to determine the action.

Thus, a conflict may also be detected when one or more of the events contradicts the domain knowledge. Similar to step 204, one contradiction may be sufficient to determine that a conflict is present or, alternatively, a conflict may only be identified when a certain fraction or threshold number of the events contradicts the domain knowledge.

The skilled person will appreciate that a conflict may be identified as a result of either or both of steps 204 and 208. Thus, in embodiments in which only a single contradiction is needed for a conflict to be identified, the contradiction may be identified in either of steps 204 and 208. In embodiments in which a conflict is only deemed to be present if a threshold number of contradicts is identified, then the conflicts may arise from the comparison in 204, the comparison in step 208 or both of the comparisons.

If the conflict detector 110 identifies a conflict in step 210, then the conflict detector 110 requests further verification from the action verifier 112. The conflict detector 110 may thus, for example, send a conflict indicator to the action verifier 112. The conflict detector 110 may also send the model inputs and the proposed action to the action verifier 112. The action verifier 112 may notify a human verifier (e.g. by sending a message or displaying a notification) that the proposed action needs to be checked before it is performed.

Based on the further verification, the action verifier 112 initiates or discards the action. Thus, the action verifier 112 may initiate the action (e.g. cause it to be performed) in response to approval of the proposed action by an operator. Alternatively, the action verifier 112 may discard the action if it is disapproved by an operator. The action verifier 112 may, in response to discarding the action, request a new action proposal from the model 102.

This additional verification step may be omitted, and the proposed action may simply be discarded (e.g. not performed) when a conflict is detected.

If, in step 210, no conflict is identified, the method proceeds to step 212, in which the action is initiated. Thus, the action may be performed by the system 100 or, alternatively, the system 100 may instruct another node or entity to perform the action.

The method 200 thus employs domain knowledge to verify the actions proposed by a reinforcement learning model. In this method, inputs to the model 102 are processed in one of two ways to enable comparison with the domain knowledge: inputs may either be classified in step 202 or inputs may be mapped to events in step 206. The skilled person will appreciate that either of these processing techniques may still be advantageous even when the other is omitted. Thus, for example, the method 200 may be adapted to omit steps 202 and 204 such that all inputs are mapped to events in step 206. Accordingly, the system 100 described above may be adapted to omit the input classifier 102 such that all inputs are instead sent to the input mapper 106. In these examples, conflicts may be determined to occur solely based on any contradictions between events provided by the input mapper 106 and the domain knowledge. This may be particularly advantageous for fields in which the model inputs typically comprise low-level parameters (e.g. raw measurement data), but the domain knowledge is typically abstracted in terms of higher level representations or concepts.

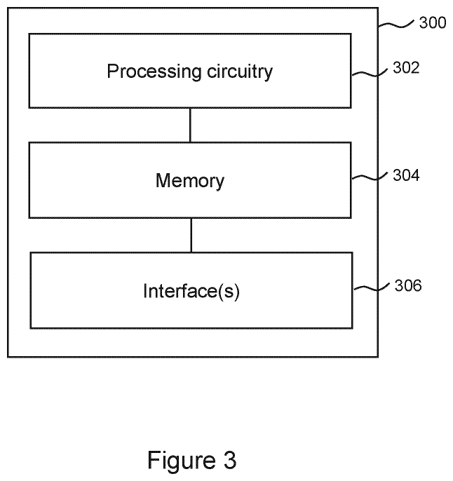

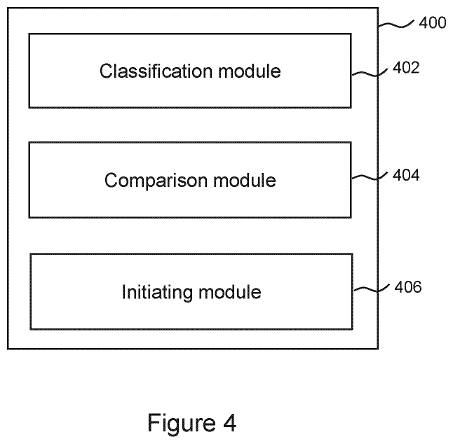

It is further noted that, although the method 200 is described above as being performed by the system 100, the skilled person will appreciate that the method may be performed by any computer-implemented apparatus, such as those discussed below in respect of FIGS. 3 and 4.

As discussed above, reinforcement learning models operating in a large state space and/or models that were developed using deep reinforcement learning may be particularly difficult to validate. The methods described herein may be particularly advantageous for these types of models, which are applied in a wide variety of domains. In addition, these methods may also be particularly advantageous in risk-sensitive fields, such as autonomous vehicles, robotics, smart factories, etc, since the impact of performing an action arising from flawed logic may be significant in these fields. As a result, the skilled person will appreciate that there are various domains in which the methods described herein may be advantageously applied.

One such domain is communication networks and, in particular, the configuration of network operational parameters in order to optimise network performance. Thus, in an embodiment, the method 200 may be performed by a node in a communication network. The skilled person will appreciate that the features discussed above in respect of the method 200 also apply when the method 200 is implemented in a node in a communication network. Further details specific to this implementation are as follows.

The node may comprise any component or network function (e.g. any hardware or software module) in the communication network that is suitable for performing the method 200. For example, a node may comprise equipment capable, configured, arranged and/or operable to communicate directly with a wireless device (e.g. a user equipment, UE) and/or with other network nodes or equipment in the communication network to enable and/or provide wireless or wired access to the wireless device and/or to perform other functions (e.g. administration) in the communication network. Examples of nodes include, but are not limited to, base stations (e.g. radio base stations, Node Bs, evolved Node Bs, and gNBs) and core network nodes or functions such as, for example, core network functions in a Fifth Generation Core (5GC) network or core network nodes in an Evolved Packet Core (EPC) network.

The communication network may implement any suitable communications protocol or technology, including wireless communications technologies such as Global System for Mobile communication (GSM), Wide Code-Division Multiple Access (WCDMA), Long Term Evolution (LTE), New Radio (NR), WiFi, WIMAX, or Bluetooth wireless technologies. In one particular example, the communication network forms part of a cellular telecommunication network, such as the type developed by the 3rd Generation Partnership Project (3GPP). The communication network may thus, for example, form part of a Fourth or Fifth Generation (4G or 5G) network.

As discussed in respect of the method 200, an action to be performed is determined by a model based on a plurality of inputs.

The plurality of inputs may comprise one or more metrics indicative of the performance of the communication network. The metrics may thus comprise key performance indicators (KPIs) indicative of, for example, load, latency, performance of one or more wireless devices, and/or throughput etc.

The inputs may further comprise one or more operational parameters of the network (e.g. configuration management parameters), indicating the configuration of one or more nodes in the network. Thus, the inputs may also indicate the current configuration of the network (e.g. before any proposed action is performed). For example, the inputs may comprise one or more configuration parameters of a base station such as a tilt angle, a downlink transmission power, the P0 nominal PUSCH, an alpha value, one or more carrier frequencies or any other suitable operational parameter.

The action proposed by the model may comprise configuring an operational parameter of the communication network. Thus, for example, the model may propose configuring an operational parameter of a base station in the communication network, such as any of those provided above.

The model may be executed by the node itself. For example, the node may be a core network node configured to receive one or more measurements from a base station in the radio access network. The core network node may thus input the measurements to the model to determine an action to be performed (e.g. an action to be performed by the base station).

Alternatively, the node may receive the proposed action from another node in the network. For example, the node may be a base station that sends one or more measurements to a core network node to be used as inputs to the model and receives, from the core network node, an action to perform.

The node classifies at least one of the model inputs as being supportive or resistant to the proposed action, in accordance with step 202. In step 204, the node compares the classification of the model inputs to the domain knowledge to determine, in step 210, whether there is a conflict between the proposed action and the domain knowledge. For example, the node may determine that there is no conflict between a proposal to uptilt the antenna beam angle of a base station based on measurements indicating that coverage is bad and interference is low by comparing a classification of the measurements as supportive with domain knowledge indicating that this action should be performed when coverage is bad or interference is low.

The node may, optionally, map one or more other inputs to the model to one or more events, in accordance with step 206. The node may then, in step 208, compare the events with the domain knowledge to determine, in step 210, whether a conflict is present.

The node may map the one or more other inputs to events using a mapping model developed using a machine learning process. In an embodiment, the mapping model classifies measurements of a cell served by a base station (the inputs to the model which proposed the action) as one of a plurality of cell conditions or issues. Exemplary cell issues include: the cell having limited coverage or capacity, the cell having high (uplink or downlink) interference, latency issues and/or channel quality issues.

In a particular embodiment, the node inputs data representing received signal power at a base station serving a cell over a period of time and data representing a plurality of performance metrics for the cell over the time period into the mapping model and obtains, from the mapping model, a cell impact class, in which the cell impact class comprises an event indicating the impact of cell interference on cell performance. For example, the mapping model may map the input data to a cell impact class indicating that uplink activity in the cell is high. A detailed example of such a mapping model is provided in Annex A.

Mapping the inputs to events enables conflicts between the inputs and the domain knowledge to be identified even when the inputs and the domain knowledge are not directly comparable (e.g. because they are parameterised differently). As a result, conflicts between low-level network metrics (e.g. metrics that are not easily interpreted) and higher-level domain knowledge may still be identified.

If a conflict is detected in step 210, the node may, in step 214, request additional verification of the proposed action. Alternatively, the node may determine not to initiate the action (e.g. discard the action) in response to detecting the conflict.

If no conflict is detected, the node initiates the action in step 212. Thus, the node may initiate a change or adjustment of a network operational parameter. For example, the node may instruct a base station to change one of its operational parameters, such as its tilt angle, transmission power, sector shape or any other suitable parameter. Alternatively, the node may change the network parameter itself. For example, the node may be a base station and the node may change its own tilt angle.

The methods described herein may thus be applied in communication networks to verify actions proposed by models developed using reinforcement learning. This can improve network performance by reducing the risk of actions that may be detrimental to network performance being performed, whilst still allowing novel insights of a model developed using reinforcement learning to be fully utilised.

FIG. 3 is a schematic diagram of an apparatus 300 for determining whether to perform an action proposed by a model developed using a reinforcement learning process according to embodiments of the disclosure. The apparatus 300 may be, for example, the node in a communication network described above. The apparatus 300 may be operable to carry out the example method 200 described with reference to FIG. 2 and possibly any other processes or methods disclosed herein. It is also to be understood that the method 200 of FIG. 2 may not necessarily be carried out solely by the apparatus 300. At least some operations of the method can be performed by one or more other entities.

The apparatus 300 comprises processing circuitry 302 (such as one or more processors, digital signal processors, general purpose processing units, etc), a machine-readable medium 304 (e.g., memory such as read-only memory (ROM), random-access memory, cache memory, flash memory devices, optical storage devices, etc) and one or more interfaces 306.

In one embodiment, the machine-readable medium 304 stores instructions which, when executed by the processing circuitry 302, cause the apparatus 300 to classify at least one of a plurality of inputs to the model as being supportive or resistant to a proposed action by the model. The apparatus is further caused to compare the classification of the at least one of the plurality of inputs to domain knowledge to determine whether or not the proposed action conflicts with the domain knowledge, in which the domain knowledge is indicative of a relationship between the proposed action and the at least one of the plurality of inputs. The apparatus is further caused to, in response to determining that the proposed action does not conflict with the domain knowledge, initiate the proposed action.

In other embodiments, the processing circuitry 302 may be configured to directly perform the method, or to cause the apparatus 300 to perform the method, without executing instructions stored in the non-transitory machine-readable medium 304, e.g., through suitably configured dedicated circuitry.

The one or more interfaces 306 may comprise hardware and/or software suitable for communicating with other nodes of the communication network using any suitable communication medium. For example, the interfaces 306 may comprise one or more wired interfaces, using optical or electrical transmission media. Such interfaces may therefore utilize optical or electrical transmitters and receivers, as well as the necessary software to encode and decode signals transmitted via the interface. In a further example, the interfaces 306 may comprise one or more wireless interfaces. Such interfaces may therefore utilize one or more antennas, baseband circuitry, etc. The components are illustrated coupled together in series; however, those skilled in the art will appreciate that the components may be coupled together in any suitable manner (e.g., via a system bus or suchlike).

In further embodiments of the disclosure, the apparatus 300 may comprise power circuitry (not illustrated). The power circuitry may comprise, or be coupled to, power management circuitry and is configured to supply the components of apparatus 300 with power for performing the functionality described herein. Power circuitry may receive power from a power source. The power source and/or power circuitry may be configured to provide power to the various components of apparatus 300 in a form suitable for the respective components (e.g., at a voltage and current level needed for each respective component). The power source may either be included in, or external to, the power circuitry and/or the apparatus 300. For example, the apparatus 300 may be connectable to an external power source (e.g., an electricity outlet) via an input circuitry or interface such as an electrical cable, whereby the external power source supplies power to the power circuitry. As a further example, the power source may comprise a source of power in the form of a battery or battery pack which is connected to, or integrated in, the power circuitry. The battery may provide backup power should the external power source fail. Other types of power sources, such as photovoltaic devices, may also be used.

FIG. 4 is a schematic diagram of an apparatus 400 for determining whether to perform an action proposed by a model developed using a reinforcement learning process according to embodiments of the disclosure. The apparatus 400 may be, for example, the node in a communication network described above. The apparatus 400 may be operable to carry out the example method 200 described with reference to FIG. 2 and possibly any other processes or methods disclosed herein. It is also to be understood that the method 200 of FIG. 2 may not necessarily be carried out solely by the apparatus 400. At least some operations of the method can be performed by one or more other entities.

The apparatus 400 comprises a classification unit 402, which is configured to classify at least one of a plurality of inputs to the model as being supportive or resistant to a proposed action by the model. The apparatus 400 further comprises a comparison unit 404, which is configured to compare the classification of the at least one of the plurality of inputs to domain knowledge to determine whether or not the proposed action conflicts with the domain knowledge, wherein the domain knowledge is indicative of a relationship between the proposed action and the at least one of the plurality of inputs. The apparatus 400 further comprises an initiating unit 406, which is configured to initiate the proposed action in response to determining that the proposed action does not conflict with the domain knowledge.

Thus, for example, the classification unit 402, the comparison unit 404 and the initiating unit 406 may be configured to perform steps 202, 204 and 206, and 212 (described above in respect of FIG. 2) respectively.

The apparatus 400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause the classification unit 402, the comparison unit 404 and the initiating unit 406, and any other suitable units of apparatus 400 to perform corresponding functions according one or more embodiments of the present disclosure.

The apparatus 400 may additionally comprise power-supply circuitry (not illustrated) configured to supply the apparatus 400 with power.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

### Annex A

A mapping model is provided. The mapping model is configured to detect interference conditions at a cell in a wireless cellular network and to classify the impact of detected interference conditions on performance of the network in the cell.

The mapping model is generated and trained according to the following method. In a first step, data representing received signal power at a base station serving the cell of the wireless network over a period of time, along with a classification of the received signal power data into one of a plurality of cell interference conditions, is obtained. The data representing received signal power at the base station may comprise interference signal power expressed per Physical Resource Block (PRB), and may in some examples comprise time series data. The classification may be obtained from a human domain expert or from an automated or ML process. The plurality of cell interference conditions may be predefined.

The method further comprises obtaining data representing a plurality of performance metrics for the cell over the time period, as well as a classification of the performance metric data into one of a plurality of cell impact classes. The classification may be obtained from a human domain expert or from an automated or machine learning process.

The performance metrics may relate to the load experienced by the cell, the radio conditions experienced by terminal devices served by the cell, etc. It will be appreciated that the method is not limited to the relatively few well known performance metrics that are frequently used in network management methods but may include a relatively large number of performance metrics, including otherwise unconventional performance metrics. For example, the performance metrics may include one or more of:
Active number of downlink and uplink users per Time Transmission Interval (TTI)
Downlink and uplink scheduling entities per TTI
Radio resource control (RRC) connection attempts
Average and maximum number RRC connected users
Downlink and uplink data volume for Data Radio Bearer (DRB) traffic
Downlink and uplink data volume for Signaling Radio Bearer (SRB) traffic
Downlink and uplink Physical Resource Block (PRB) utilization
Physical Downlink Control Channel (PDCCH) Control Channel Element (CCE) load
Average Channel Quality Indicator (CQI)
Rate of CQI below a threshold (e.g. below 6)
Downlink and Uplink user throughput
Downlink and Uplink cell throughput
Radio Access Channel (RACH) attempts
Random access success ratio
Downlink and uplink Hybrid ARQ (HARQ) discontinuous transmission ratio
Average Physical Uplink Shared Channel (PUSCH) Signal-to-Noise-Ratio (SINR)
Average Physical Uplink Control Channel (PUCCH) SINR
PUSCH SINR below −2 dB rate
PUCCH SINR below 0 dB rate
PUSCH interference level
PUCCH interference level
Average pathloss
Pathloss below 130 dB rate
UE power limitation rate
Average processor load
90th percentile of processor load

These initial steps of the method are carried out for each of a plurality of cells in the wireless cellular network. Thus, the model is developed using received signal power data and performance metric data for a plurality of cells in the network.

The method further comprises applying a multi-task learning (MTL) machine learning process to a training data set comprising the classified received signal power and classified performance metric data to generate the mapping model for classifying received signal power data into one of the plurality of cell interference conditions (as a primary task) and for classifying performance metric data into one of the plurality of cell impact classes (as an auxiliary task). In this context, an MTL machine learning process comprises a learning specification operable for execution on a computational model, which specification solves more than one learning task concurrently, exploiting commonalities between the tasks. The computational model on which the MTL machine learning process is executed may for example comprise a neural network such as a deep neural network. In some examples of the present disclosure, the neural network on which the MTL machine learning process is executed may be a convolutional neural network.

The mapping model is thus obtained by applying an MTL machine learning process to two sets of input data, in which each set of input data is specific to one of the tasks to be carried out by the trained model. The received signal power data is input data for the task of detecting interference conditions, and the performance metric data is input data to the task of classifying a cell performance impact of the detected interference conditions.

Once trained, the mapping model may be used to perform the two tasks of detecting cell interference conditions and classifying performance impact of detected conditions. Thus, in effect, the mapping model may be used to map time series interference and performance data (e.g. relative low-level parameters) to cell performance conditions, in which the cell conditions indicate one or more of: load (e.g. cell load, signalling load, processor load, downlink utilisation and/uplink utilisation), cell coverage (e.g. overshooting, contention-based random access coverage), cell performance (e.g. multiple input multiple output, MIMO, performance), mobility (e.g. handover oscillation, handover preparation, handover execution, inter-radio access technology handover), accessibility (e.g. random access channel, RACH, access) and interference (e.g. on the physical uplink shared channel, PUSCH and/or the physical uplink control channel, PUCCH).

1. A computer-implemented method for determining whether to perform an action proposed by a model developed using a reinforcement learning process, the method comprising:
classifying at least one of a plurality of inputs to the model as being supportive or resistant to a proposed action by the model;
comparing the classification of the at least one of the plurality of inputs to domain knowledge to determine whether or not the proposed action conflicts with the domain knowledge, wherein the domain knowledge is indicative of a relationship between the proposed action and the at least one of the plurality of inputs; and
in response to determining that the proposed action does not conflict with the domain knowledge, initiating the proposed action.

2.-18. (canceled)

19. An apparatus for determining whether to perform an action proposed by a model developed using a reinforcement learning process, the apparatus comprising a processor and a machine-readable medium, wherein the machine-readable medium contains instructions executable by the processor such that the apparatus is operable to:
classify at least one of a plurality of inputs to the model as being supportive or resistant to a proposed action by the model;
compare the classification of the at least one of the plurality of inputs to domain knowledge to determine whether or not the proposed action conflicts with the domain knowledge, wherein the domain knowledge is indicative of a relationship between the proposed action and the at least one of the plurality of inputs; and
in response to determining that the proposed action does not conflict with the domain knowledge, initiate the proposed action.

20. The apparatus of claim 19, wherein the apparatus is operable to classify at least one of the plurality of inputs as being supportive or resistant using an explainable artificial intelligence, XAI, process.

21. The apparatus of claim 19, wherein the apparatus is further operable to:
determine a relative importance of one of the plurality of inputs to the proposed action compared to at least one other input in the plurality of inputs; and
select the input for comparison with the domain knowledge based on its relative importance.

22. The apparatus of claim 21, wherein the apparatus is operable to determine the relative importance of the input using an XAI process.

23. The apparatus of claim 19, wherein the apparatus is operable to compare the classification of the at least one of the plurality of inputs to domain knowledge to determine whether or not the proposed action conflicts with the domain knowledge by:
determining that a conflict occurs in response to determining that one or more inputs have a classification that contradicts the domain knowledge.

24. The apparatus of claim 19, wherein the apparatus is further operable to:
map one or more other inputs to the model to one or more events for comparison with the domain knowledge; and
compare the set of events with the domain knowledge to determine whether or not the proposed action conflicts with the domain knowledge.

25. The apparatus of claim 24, wherein the apparatus is operable to map one or more other inputs to one or more events using a mapping model developed using a machine learning process.

26. The apparatus of claim 19, wherein the apparatus is a node in a communication network.

27. The apparatus of claim 26, wherein the communication network comprises a radio access network and the plurality of inputs comprises one or more metrics of the radio access network and the proposed action comprises configuring an operational parameter of the radio access network.

28. The apparatus of claim 26, wherein the node comprises a base station or a core network node.

29. The apparatus of claim 27, wherein the apparatus is further operable to:
map other metrics of the radio access network that are input to the model to one or more events for comparison with the domain knowledge; and
compare the set of events with the domain knowledge to determine whether or not the proposed action conflicts with the domain knowledge.

30. The apparatus of claim 29, wherein the other metrics comprise data representing received signal power at a base station in the radio access network over a period of time and data representing a plurality of performance metrics for a cell served by the base station over the time period and wherein the apparatus is operable to map one or more other metrics to one or more events using a mapping model developed using a machine learning process.

31. The apparatus of claim 30, wherein the machine learning process is a multi-task learning process.

32. The apparatus of claim 19, wherein the reinforcement learning process is a policy optimisation process or a q-learning process.
